(19) United States
(12) Patent Application Publication
(10) Pub. No.: US 2026/0328257 A1
(43) Pub. Date: Oct. 22, 2026

(54) VIBRATION DAMPER FOR A VEHICLE

(71) Applicants: thyssenkrupp Bilstein GmbH, Ennepetal (DE); thyssenkrupp AG, Essen (DE)

(72) Inventors: Michael FRITZ, Breckerfeld (DE); Henning BOEKHOFF, Wuppertal (DE)

(73) Assignees: thyssenkrupp Bilstein GmbH, Ennepetal (DE); thyssenkrupp AG, Essen (DE)

(21) Appl. No.: 19/529,267

(22) Filed: Feb. 4, 2026

(30) Foreign Application Priority Data
Feb. 4, 2025 (DE) 10 2025 104 065.6

(51) Int. Cl. F16F 9/48

(52) U.S. Cl. CPC F16F 9/48; F16F 2230/0041; F16F 2232/08; F16F 2238/026

(57) ABSTRACT

A vibration damper for a vehicle comprises a damper tube filled with hydraulic fluid, a working piston, which is connected to a piston rod and is arranged movably back and forth within the damper tube, the interior of the damper tube being divided by the working piston into a first working chamber on the piston rod side and a second working chamber away from the piston rod, a rebound stage suspension arrangement for additional spring suspension of the piston movement in the rebound stage, comprising a rebound stage piston, which is mounted on the piston rod, and a rebound stage spring, and a compression stage suspension arrangement for additional spring suspension of the piston movement in the compression stage, comprising a compression stage piston and a compression stage spring.

### CROSS REFERENCE TO RELATED APPLICATION

This application is a U.S. Non-Provisional that claims priority to German Patent Application No. DE 10 2025 104 065.6, filed Feb. 4, 2025, the entire content of which is incorporated herein by reference.

### FIELD

The present disclosure relates to a vibration damper, in particular a steering damper, for a vehicle, comprising a rebound stage suspension arrangement and a compression stage suspension arrangement.

### BACKGROUND

Vibration dampers, in particular a steering damper, are usually used to stabilize the steering when there is a high degree of excitation, in particular in the case of travel on very uneven terrain or cornering at high speeds.

DE102017113299 A1 discloses a steering damper. It has been found to be a problem that when there is a high degree of excitation combined with an excessively low or excessively high damping force, the starting position of the steering damper, i.e. the position in which the vehicle is travelling straight ahead, is reached only after a delay. This results in steady-state circular travel. In such cases, travelling straight ahead requires a corresponding manual action by means of the steering wheel. In the worst case, in particular if the damping force is too low, the external excitation on the steering causes oscillations to build up, resulting in “shuddering”. This presents a very high safety risk.

Thus a need exists to specify a vibration damper, in particular a steering damper, which reliably returns to its starting position after an excitation, so that the vehicle is automatically set to travel in a straight line.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a two-tube vibration damper in a longitudinal sectional view according to one exemplary embodiment.

FIG. 2 shows a schematic illustration of a single-tube vibration damper in a longitudinal sectional view according to a further exemplary embodiment.

FIG. 3 shows a schematic illustration of a single-tube vibration damper in a longitudinal sectional view according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper for a vehicle comprises a damper tube filled with hydraulic fluid, and a working piston, which is connected to a piston rod and is arranged movably back and forth inside the damper tube, the interior of the damper tube being divided by the working piston into a first working chamber and a second working chamber. The vibration damper also comprises a rebound stage suspension arrangement for applying a spring force to the working piston during a piston rod movement in the rebound direction, comprising a rebound stage piston, which is mounted on the piston rod, and a rebound stage spring. The vibration damper also comprises a compression stage suspension arrangement for applying a spring force to the working piston during a piston rod movement in the compression direction, comprising a compression stage piston and a compression stage spring.

The vibration damper is preferably a steering damper, which is mounted between an axle of a vehicle, in particular the steering axle, and the steering rod and/or the vehicle body. An additional spring suspension of the piston rod movement in the compression stage and in the rebound stage ensures a reliable alignment of the working piston in the centre position, so that in the case of a steering damper, travel straight ahead is set automatically after a deflection.

The vibration damper is, for example, a single-tube or multi-tube vibration damper. For example, a multi-tube vibration damper for a vehicle comprises an outer tube and an inner tube coaxial with the outer tube, with a compensation chamber for receiving hydraulic fluid being formed between the outer tube and the inner tube, and comprises a working piston, which is connected to a piston rod and is arranged movably back and forth inside the inner tube, the interior of the inner tube being divided by the working piston into a first working chamber and a second working chamber. The compensation chamber is preferably at least partially filled with a gas, in particular at the upper end. The outer tube preferably forms at least partially the housing of the vibration damper. The inner surface of the inner tube is preferably formed as a guide of the working piston. The working piston preferably has a valve device by which the first and the second working chamber are connected to each other. The inner tube has in particular at least one through-opening, which fluidically connects the first working chamber on the piston rod side to the annular chamber, the through-opening being formed in the first working chamber. In the case of a single-tube vibration damper, an outer tube is preferably not provided. The inner tube is referred to as the damper tube and, as described above with respect to the inner tube, receives the piston rod and the working piston.

In the case of a multi-tube vibration damper, the vibration damper has in particular a closure package which is designed and arranged to seal off the interior of the outer tube fluidically on the piston rod side. The end of the inner tube on the piston rod side is preferably fastened to the closure package. At the end away from the piston rod, opposite the closure package, the interior of the outer tube is preferably fluidically sealed off by means of a bottom piece. A bottom valve, which is mounted in particular at the end of the inner tube or outer tube away from the piston rod, is located in particular on the bottom piece. The second working chamber is preferably fluidically connected to the compensation chamber via the bottom valve. The bottom valve is preferably a check valve through which flow can pass in both directions or only in one direction. For example, the bottom valve is designed as a check valve in the rebound direction, in the case of a piston movement in a direction out of the inner tube, and is designed as a characteristic-defining valve in the compression direction, in the case of a piston movement into the inner tube.

In the case of a single-tube vibration damper, the vibration damper has in particular a closure package which is designed and arranged to seal off the interior of the damper tube fluidically on the piston rod side. The end of the damper tube on the piston rod side is preferably fastened to the closure package. Opposite from the closure package, at the end away from the piston rod, the interior of the damper tube is preferably fluidically sealed off by means of an axially movable sealing element. The sealing element preferably separates a gas chamber, adjoining it in the axial direction, from a hydraulic chamber filled with hydraulic fluid. For example, the vibration damper does not have a bottom valve but merely a bottom piece, the bottom piece forming a fluid-tight closure of the damper tube, and an adjustment valve is provided which is external with respect to the damper tube and generates the damping action for example in the compression direction. It is also conceivable, in particular in the case of a single-tube vibration damper, to replace the bottom piece with a separating piston which separates the working chamber that is away from the piston rod from a gas chamber.

In the following description, the term vibration damper should be understood as meaning both a multi-tube vibration damper and a single-tube vibration damper, the damper tube being the inner tube of a multi-tube vibration damper. In the following, a movement in the rebound direction is understood as a movement in the direction of the closure package into the region of the shock absorber on the piston rod side, and a movement in the compression direction is understood as a movement in the direction of the bottom valve into the region of the shock absorber away from the piston rod. The closure package is preferably coaxial with the piston rod and encloses the latter around the circumference.

The rebound stage piston is preferably fixedly mounted on the piston rod. In particular, the rebound stage piston is located in the working chamber on the piston rod side, between the working piston and the closure package. In particular, the rebound stage piston has a smaller diameter than the inside diameter of the damper tube, so that an annular gap through which hydraulic fluid can flow is formed between the inner wall of the damper tube and the outer surface of the rebound stage piston. With preference, the rebound stage piston, in particular the annular gap, is formed in such a way that the rebound stage piston presents no or only very little hydraulic resistance during a piston rod movement. For example, the rebound stage piston has a plurality of flow passages, through which hydraulic fluid can flow. The flow passages are provided for example in addition to the annular chamber or as an alternative to the annular chamber. For example, the rebound stage piston lies with its outer surface completely or partially against the inner surface of the damper tube, so that no annular chamber is formed.

The rebound stage piston is mounted on the piston rod in particular at a spacing from the working piston. It is also conceivable that the rebound stage piston lies directly against the working piston or is formed in one piece or integrally with the working piston.

The compression stage piston preferably lies against the damper tube, so that the damper tube forms an axial guide of the compression stage piston. The piston rod can preferably move relative to the compression stage piston. The compression stage piston is preferably mounted between the working piston and the bottom valve and can preferably move axially inside the damper tube. In particular, the compression stage piston has a plurality of flow passages, so that hydraulic fluid can flow therethrough. With preference, the compression stage piston is formed in such a way that it presents no or only very little hydraulic resistance during a movement of the compression stage piston. Optionally, the compression stage piston has a diameter which is smaller than the inside diameter of the damper tube, so that an annular gap through which hydraulic fluid can flow is formed between the damper tube and the compression stage piston. The flow passages are provided for example in addition to the annular chamber or as an alternative to the annular chamber.

The compression stage piston is in particular at a spacing from the working piston. Optionally, the compression stage piston lies directly against the working piston or is formed in one piece or integrally with the working piston.

According to a first embodiment, the rebound stage suspension arrangement and the compression stage suspension arrangement are mechanically separate from one another inside the vibration damper. With preference, the rebound stage suspension arrangement and the compression stage suspension arrangement are not mechanically coupled to one another. The rebound stage suspension arrangement is preferably designed and arranged in such a way that it counteracts the piston movement exclusively in the rebound stage, in particular applies a force to the piston rod in the compression direction, the compression stage suspension arrangement being designed and arranged in such a way that it counteracts the piston movement exclusively in the compression stage, in particular applies a force to the piston rod in the rebound direction. In particular the rebound stage suspension arrangement is inactive in the case of a piston rod movement in the compression direction, and the compression stage suspension arrangement is preferably inactive in the case of a piston rod movement in the rebound direction. This has the effect of controlledly moving the working piston in the direction of the centre position when it has been deflected out of the centre position.

According to a further embodiment, the rebound stage suspension arrangement and the compression stage suspension arrangement are designed and arranged such that they apply a force to the working piston in the direction of the centre position of the working piston, in which the working piston is located in the axial centre of the damper tube. With preference, the rebound stage suspension arrangement and the compression stage suspension arrangement are each designed in such a way that the force increases with the deflection travel of the working piston.

According to a further embodiment, the piston rod is movable within a movement range in which both the rebound stage suspension arrangement and the compression stage suspension arrangement are inactive, in particular do not produce any additional spring suspension effect. With preference, this movement range extends over a portion of the damper tube, in particular over 10% to 40%, preferably 20% to 30% of the length of the damper tube. With preference, the movement range includes the centre position of the working piston, in which the working piston is arranged in the centre of the damper tube. Within this movement range, the piston rod movement is damped exclusively by a valve device of the working piston.

According to a further embodiment, the movement range includes the centre position of the piston rod, in which the working piston is arranged in the axial centre of the damper tube. In the centre position of the working piston, there is no deflection and therefore no steering movement; in particular, when the working piston is in the centre position, the vehicle travels straight ahead.

According to a further embodiment, one end of the rebound stage spring and one end of the compression stage spring are fastened inside the damper tube. The respective opposite end is in particular freely movable and preferably can lie against a spring seat located inside the damper tube. With preference, exclusively one end of the rebound stage spring and exclusively one end of the compression stage spring are fastened inside the damper tube. Optionally, both ends of the rebound stage spring and both ends of the compression stage spring are fastened inside the damper tube.

According to a further embodiment, the rebound stage spring is fastened to the rebound stage piston and/or to a rebound stage spring seat located inside the damper tube. With preference, the compression stage suspension arrangement has a compression stage spring seat for supporting the compression stage spring in the compression stage and the rebound stage suspension arrangement has a rebound stage spring seat for supporting the rebound stage spring in the rebound stage. In particular, the rebound stage piston has, on its surface facing in the direction of the closure package, a fastening device for fastening the rebound stage spring. The fastening device is designed for example in the form of a groove, which extends in a circle around and coaxially with the piston rod. In particular, the groove extends around the outer circumference of the rebound stage piston, and one end, in particular an end winding, of the rebound stage spring is clamped or pressed in the groove. The rebound stage spring is preferably designed in the form of a helical spring and extends coaxially with and around the piston rod. In particular, the rebound stage spring is mounted with the ability to move relative to the damper tube and one end of the rebound stage spring is fastened to the rebound stage piston. The other, opposite end of the rebound stage spring is preferably free and, in a position in which the rebound stage piston is deflected in the rebound direction, lies against the rebound stage spring seat. Optionally, the rebound stage spring is additionally or exclusively fastened to the rebound stage spring seat.

The rebound stage spring seat is preferably mounted on the end region of the damper tube facing in the rebound direction and is optionally connected to the closure package. The rebound stage spring seat is for example fastened to the inner side of the damper tube and preferably fluid-tightly terminates therewith. The rebound stage spring seat is preferably at a spacing from the piston rod. In particular, an annular gap is formed between the rebound stage spring seat and the piston rod.

According to a further embodiment, the compression stage spring is fastened to the compression stage piston and/or to a compression stage spring seat located inside the damper tube. In particular, the compression stage piston has, on its surface facing in the direction of the bottom valve, a fastening device for fastening the compression stage spring. The fastening device is designed for example in the form of a groove, which extends in a circle around and coaxially with the damper tube. With preference, the groove extends around the outer circumference of the compression stage piston, and one end, in particular an end winding, of the compression stage spring is clamped or pressed in the groove. The compression stage spring is preferably designed in the form of a helical spring and extends coaxially with the damper tube. In particular, the compression stage spring is mounted with the ability to move relative to the damper tube and one end of the compression stage spring is fastened to the compression stage piston. The other, opposite end of the compression stage spring is preferably free and, in a position in which the compression stage piston is deflected in the compression direction, lies against the compression stage spring seat. Optionally, the compression stage spring is additionally or exclusively fastened to the compression stage spring seat.

The compression stage spring seat is preferably mounted on the end region of the damper tube facing in the compression direction and is by way of example connected to the bottom valve or the bottom piece. The compression stage spring seat is for example fastened to the side of the bottom valve facing in the direction of the second working chamber. The compression stage spring seat is for example annular and preferably has an outside diameter equal to or smaller than the inside diameter of the compression stage spring. With preference, when the compression stage piston is in a state deflected in the compression direction, the inside diameter of the compression stage spring lies against the outer circumference of the compression stage spring seat. In addition, preferably when the compression stage piston is in a state deflected in the compression direction, the end of the compression stage spring opposite the compression stage piston lies against the bottom valve or the bottom piece.

According to a further embodiment, the rebound stage spring and/or the compression stage spring are mounted with the ability to move axially inside the damper tube. According to a further exemplary embodiment, the rebound stage spring and/or the compression stage spring each have an axial length which is less than half the length of the damper tube. This results in a region of axial spring suspension, the respective spring being compressed by the piston movement.

According to a further embodiment, the rebound stage spring and the compression stage spring have the same spring rate. This results in the same spring suspension in the case of a piston rod movement in the rebound direction or the compression direction.

According to a further embodiment, the rebound stage suspension arrangement and/or the compression stage suspension arrangement each have at least two mutually mechanically parallel springs. For example, the springs are both helical springs, one spring having a smaller diameter than the other spring and preferably being coaxial with and located inside the other spring. Such a spring arrangement ensures a greater degree of gradual spring suspension.

According to a further embodiment, the vibration damper is designed in the form of a multi-tube damper and has an outer tube arranged coaxially around the damper tube, wherein a compensation chamber at least partially filled with hydraulic fluid is located between the damper tube and the outer tube.

The present disclosure also comprises a vehicle which comprises a steering rod, a steering axle and a vibration damper as described above, the vibration damper being fastened to the steering rod and/or to the steering axle and/or to the vehicle body.

The present disclosure is explained in more detail below on the basis of several exemplary embodiments, with reference to the accompanying figures.

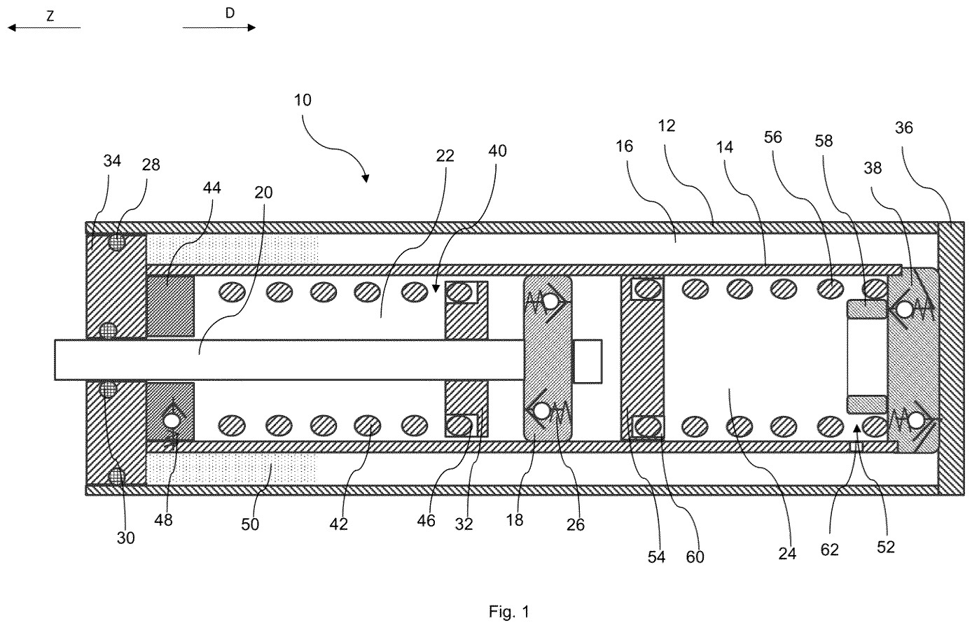

FIG. 1 shows a vibration damper 10, the vibration damper 10 being, by way of example, a multi-tube vibration damper, by way of example a 2-tube vibration damper. The vibration damper 10 is preferably designed in the form of a steering damper and is in particular mounted on the steering rod and steering axle of a vehicle, which are not illustrated in the figures. The vibration damper 10 has an outer tube 12, which forms an outer surface, in particular a housing, of the vibration damper 10. A damper tube 14, also referred to as inner tube 14, is located inside the outer tube 12, coaxially therewith. Formed between the outer tube 12 and the inner tube 14 is a compensation chamber 16, which is preferably at least partially or completely filled with a hydraulic fluid. For example, the compensation chamber 16 is partially filled with a gas.

Inside the inner tube 14, a working piston 18 connected to a piston rod 20 is arranged in such a way that it is movable within the inner tube 14, wherein the inner tube 14 is preferably designed as a guide of the working piston 18. The working piston 18 preferably has a valve device 26. For example, the valve device 26 comprises a rebound stage valve, for damping the piston movement in the rebound stage, and a compression stage valve for damping the piston movement in the compression stage. Preferably, the valves are each formed by a passage opening through the piston and a valve disc pack. The working piston 18 divides the interior of the inner tube 14 into a first working chamber 22, which is arranged on the piston rod side, and a second working chamber 24, which is arranged away from the piston rod. The piston rod 20 is preferably connectable, by way of its end protruding from the damper tube 14, to the steering axle or the steering rod of the vehicle.

The interior of the outer tube 12 is fluidically sealed off on the piston rod side by means of a closure package 34. Opposite from the closure package 34, at the end away from the piston rod, the interior of the outer tube 12 is fluidically sealed off by means of a bottom piece 36. By way of example, a bottom valve 38, which is mounted in particular on the end of the inner tube 14 away from the piston rod, is arranged on the bottom piece 36. The bottom valve 38 is preferably a check valve through which a flow can pass in both directions or only in one direction. The second working chamber 24 is preferably fluidically connected to the compensation chamber 16 by way of the bottom valve 38. The end of the inner tube 14 on the piston rod side is preferably fastened to the closure package 34.

By way of example, the outer tube 12 is sealed off in relation to the closure package 34, at the end region on the piston rod side, by means of a seal 28. With preference, the seal 28 is designed in the form of a sealing ring and is located between the outer tube 12 and the closure package 34. The closure package 34 is sealed off in relation to the piston rod 20 via a further sealing ring 30, the sealing ring being mounted by way of example in a groove in the closure package 34 and the piston rod 20 being mounted with the ability to move relative to the sealing ring 30, the piston rod preferably fluid-tightly sliding along the sealing ring 30.

The vibration damper 10 further comprises a rebound stage suspension arrangement 40 for the spring suspension of the piston movement in the rebound stage, in the rebound direction Z. The rebound stage suspension arrangement 40 comprises by way of example a rebound stage piston 32, a rebound stage spring 42 and a rebound stage spring seat 44. The rebound stage piston 32 is preferably fastened to the piston rod 20 and conjointly movable therewith. In the rebound direction Z, the rebound stage piston 32 is mounted in front of the working piston 18. In particular, the rebound stage piston 32 has a smaller diameter than the inside diameter of the damper tube 14, so that an annular gap through which hydraulic fluid can flow is formed between the inner wall of the damper tube 14 and the outer surface of the rebound stage piston 32. With preference, the rebound stage piston 32, in particular the annular gap, is formed in such a way that the rebound stage piston 32 presents no or only very little hydraulic resistance during a piston rod movement. It is also conceivable that the rebound stage piston 32 has a plurality of flow passages, through which hydraulic fluid can flow. The flow passages are provided for example in addition to the annular chamber or as an alternative to the annular chamber. For example, the rebound stage piston 32 lies with its outer surface completely or partially against the inner surface of the damper tube 14, so that no annular chamber is formed.

The rebound stage piston 32 is mounted on the piston rod 20 by way of example at a spacing from the working piston 18. Optionally, the rebound stage piston 32 is not fastened to the piston rod 20 but merely guided thereon. It is also conceivable that the rebound stage piston 32 lies directly against the working piston 18 or is formed in one piece or integrally with the working piston 18.

The rebound stage spring 42 is preferably fastened to the rebound stage piston 32. In particular, the rebound stage piston 32 has, on its surface facing in the direction of the closure package 34, a fastening device for fastening the rebound stage spring 42. The fastening device is designed for example in the form of a groove 46, which extends in a circle around and coaxially with the piston rod 20. By way of example, the groove 46 extends around the outer circumference of the rebound stage piston 32, and one end, in particular an end winding, of the rebound stage spring 42 is clamped or pressed in the groove. The rebound stage spring 42 is preferably designed in the form of a helical spring and extends coaxially with and around the piston rod 20. In particular, the rebound stage spring 42 is mounted with the ability to move relative to the damper tube 14 and one end of the rebound stage spring is fastened to the rebound stage piston 32. The other, opposite end of the rebound stage spring 42 is preferably free and, in a position in which the rebound stage piston 32 is deflected in the rebound direction, lies against the rebound stage spring seat 44. The rebound stage spring 42 preferably has an axial length which is less than half the axial length of the damper tube 14.

The rebound stage spring seat 44 is preferably mounted on the end region of the damper tube 14 facing in the rebound direction Z and by way of example is connected to the closure package 34. The rebound stage spring seat 44 is for example fastened to the inner side of the damper tube 14, and preferably fluid-tightly terminates therewith. The rebound stage spring seat 44 is for example at a spacing from the piston rod 20. In particular, an annular gap is formed between the rebound stage spring seat 44 and the piston rod 20. The rebound stage spring seat 44 has by way of example a check valve 48, which is fluidically connected to a fluid passage in the damper tube 14 and the working chamber 22 on the piston rod side. The check valve 48 is designed and arranged in such a way that it allows a flow of fluid from the compensation chamber 16 into the first working chamber 22 and prevents it in the opposite direction. A gas chamber 50 is preferably formed inside the compensation chamber 16. The gas chamber 50 is formed by way of example at the end of the compensation chamber 16 facing in the direction of the closure package 34, the fluid passage in the damper tube 14 being located in particular at the height of the gas chamber 50.

The vibration damper 10 also has a compression stage suspension arrangement 52 for the spring suspension of the piston movement in the compression stage, in the compression direction D. The compression stage suspension arrangement 52 comprises by way of example a compression stage piston 54, a compression stage spring 56 and a compression stage spring seat 58. The compression stage piston 54 preferably lies against the damper tube 14, so that the damper tube 14 forms an axial guide of the compression stage piston 54. The piston rod can preferably move relative to the compression stage piston 54. The compression stage piston 54 is preferably mounted between the working piston 18 and the bottom valve 38 and can preferably axially move inside the damper tube 14. In particular, the compression stage piston 54 has a plurality of flow passages, so that hydraulic fluid can flow therethrough. With preference, the compression stage piston 54 is formed in such a way that it presents no or only very little hydraulic resistance during a movement of the compression stage piston 54. It is also conceivable that the compression stage piston 54 has a diameter which is smaller than the inside diameter of the damper tube 14, so that an annular gap through which hydraulic fluid can flow is formed between the damper tube 14 and the compression stage piston 54. The flow passages are provided for example in addition to the annular chamber or as an alternative to the annular chamber.

The compression stage piston 54 is by way of example at a spacing from the working piston 18. It is also conceivable that the compression stage piston 54 lies directly against the working piston 18 or is formed in one piece or integrally with the working piston 18.

The compression stage spring 56 is preferably fastened to the compression stage piston 54. In particular, the compression stage piston 54 has, on its surface facing in the direction of the bottom valve 36, a fastening device for fastening the compression stage spring 56. The fastening device is designed for example in the form of a groove 60, which extends in a circle around and coaxially with the damper tube 14. By way of example, the groove 60 extends around the outer circumference of the compression stage piston 54, and one end, in particular an end winding, of the compression stage spring 56 is clamped or pressed in the groove 60. The compression stage spring 56 is preferably designed in the form of a helical spring and extends coaxially with the damper tube 14. In particular, the compression stage spring 56 is mounted with the ability to move relative to the damper tube 14 and one end of the compression stage spring is fastened to the compression stage piston 54. The other, opposite end of the compression stage spring 56 is preferably free and, in a position in which the compression stage piston 54 is deflected in the compression direction, lies against the compression stage spring seat 58. The compression stage spring 56 preferably has an axial length which is less than half the axial length of the damper tube 14.

The compression stage spring seat 58 is preferably mounted on the end region of the damper tube 14 facing in the compression direction D and is by way of example connected to the bottom valve 36 or the bottom piece 38. The compression stage spring seat 58 is for example fastened to the side of the bottom valve 38 facing in the direction of the second working chamber 24. The compression stage spring seat 58 is for example annular and preferably has an outside diameter which is equal to or smaller than the inside diameter of the compression stage spring 56. With preference, when the compression stage piston 54 is in a state deflected in the compression direction D, the inside diameter of the compression stage spring 56 lies against the outer circumference of the compression stage spring seat 58. In addition, preferably when the compression stage piston 54 is in a state deflected in the compression direction D, the end of the compression stage spring 56 opposite the compression stage piston 54 lies against the bottom valve 38 or the bottom piece 36. At the end facing in the direction of the bottom valve 38, the damper tube 14 has a further flow passage 62 for the hydraulic connection of the second working chamber 24 to the compensation chamber 16.

With preference, the rebound stage suspension arrangement 40 and the compression stage suspension arrangement 52 are mechanically separate from one another inside the vibration damper 10. The rebound stage suspension arrangement 40 is preferably designed and arranged in such a way that it counteracts the piston movement exclusively in the rebound stage, the compression stage suspension arrangement 52 being designed and arranged in such a way that it counteracts the piston movement exclusively in the compression stage. In particular the rebound stage suspension arrangement 40 is inactive in the case of a piston rod movement in the compression direction D, and the compression stage suspension arrangement 52 is preferably inactive in the case of a piston rod movement in the rebound direction Z.

With preference, the vibration damper 10 has a movement range of the piston rod 20 in which both the rebound stage suspension arrangement 40 and the compression stage suspension arrangement 52 are inactive, in particular produce no additional damping or spring suspension effect. With preference, the movement range includes the centre position of the working piston 18, in which the working piston is arranged in the centre of the damper tube 14. Within this movement range, the piston rod movement is damped exclusively by the valve device 26 of the working piston 18.

Such an arrangement of the rebound stage and compression stage suspension arrangements 40, 52 has a spring suspension effect on the piston rod movement as soon as the working piston is outside the movement range. In addition, the springs bring about a deflection of the piston rod 20 in the direction of the centre position of the working piston 18. In particular, in the case of excitation of the steering rod at high speeds, the centre position of the working piston, in which no steering movement takes place, is reliably returned to after a deflection.

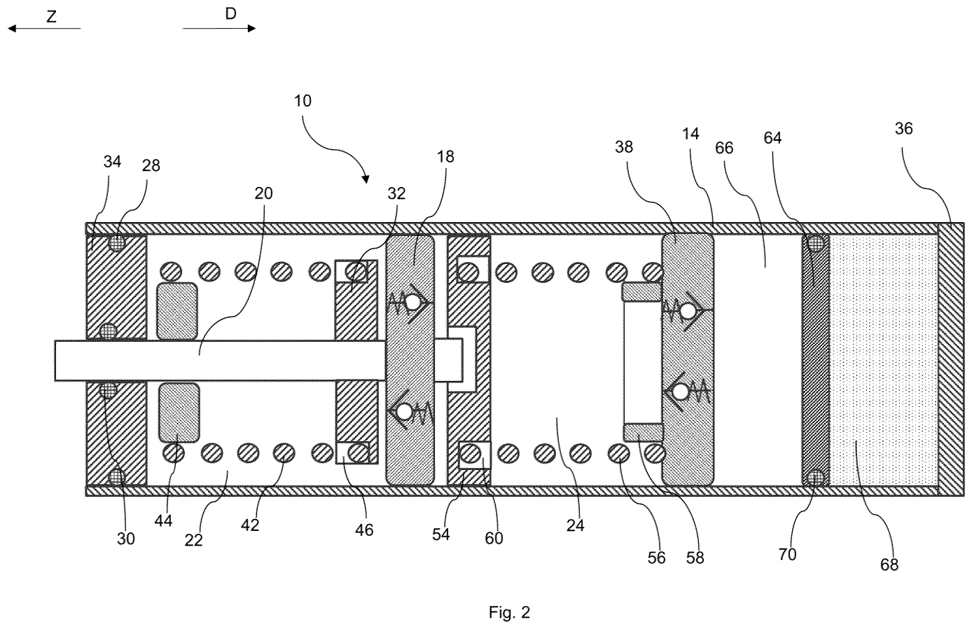

FIG. 2 shows a single-tube vibration damper 10 with a rebound stage suspension arrangement 40 and a compression stage suspension arrangement 52 which substantially correspond to the rebound stage suspension arrangement 40 and the compression stage suspension arrangement 52 in FIG. 1. By contrast to FIG. 1, the vibration damper 10 in FIG. 2 is a single-tube vibration damper comprising a damper tube 14 without an additional outer tube. The vibration damper 10 in FIG. 1 further comprises a separating piston 64, which separates a hydraulic chamber 66, located between the bottom valve 38 and the bottom piece 36, from a gas chamber 68. The separating piston 64 can move axially inside the damper tube 14 and lies fluid-tightly against the inner wall of the damper tube 14. By way of example, the separating piston 64 is fluid-tightly sealed off in relation to the damper tube 14 via a sealing ring 70. The functioning and arrangement of the rebound stage suspension arrangement 40 and of the compression stage suspension arrangement 52 substantially correspond to the embodiment described with reference to FIG. 1.

Optionally, the gas chamber 68, the separating piston 64 and the hydraulic chamber 66 are located in an external gas tank outside the damper tube 14. In this case, the hydraulic chamber 66 is fluidically connected to the interior of the damper tube 14 via the bottom valve 38 located inside the damper tube 14. Such an arrangement takes up less space.

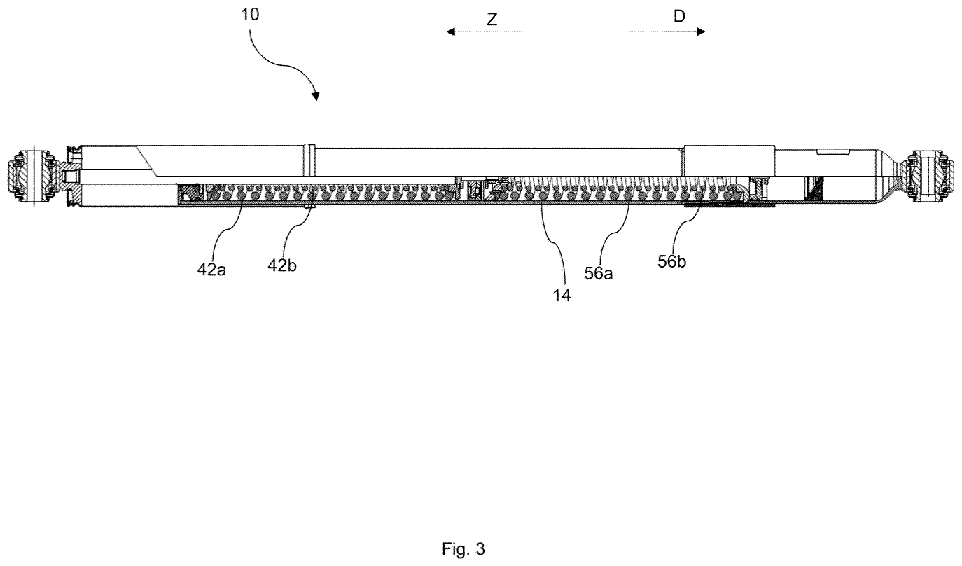

FIG. 3 shows a further exemplary embodiment of a single-tube vibration damper 10, which largely corresponds to the vibration damper in FIG. 2. In the exemplary embodiment in FIG. 3, the vibration damper 10 has by way of example four springs 42a, b and 56a, b. The rebound stage suspension arrangement 40 of the vibration damper 10 in FIG. 3 comprises by way of example two rebound stage springs 42a, b, a first rebound stage spring 42a and a second rebound stage spring 42b. The rebound stage springs 42a, b are preferably coaxial with one another, the first rebound stage spring 42a having a larger diameter than the second rebound stage spring 42b. The second rebound stage spring 42b is located in particular radially on the inside of the first rebound stage spring 42a. For example, the rebound stage springs 42a, b are mutually mechanically parallel.

The compression stage suspension arrangement 52 of the vibration damper 10 in FIG. 3 comprises by way of example two compression stage springs 56a, b, a first compression stage spring 56a and a second compression stage spring 56b. The compression stage springs 56a, b are preferably coaxial with one another, the first compression stage spring 56a having a larger diameter than the second compression stage spring 56b. The second compression stage spring 56b is located in particular radially on the inside of the first compression stage spring 56a. For example, the compression stage springs 56a, b are mutually mechanically parallel.

The rebound stage piston 32 and the compression stage piston 54 are mounted in particular on the working piston 18. FIG. 3 shows an undeflected state of the working piston 18, which is in the centre position. By way of example, when the working piston 18 is in the centre position, the rebound stage springs 42a, b and the compression stage springs 56a, b extend from the rebound stage piston 32 and the compression stage piston 54 to the rebound stage spring seat 44 and the compression stage spring seat 58, respectively. The vibration damper 10 in FIG. 3 has, by way of example, no movement range of the piston rod 20 in which both the rebound stage suspension arrangement 40 and the compression stage suspension arrangement 52 are inactive, in particular produce no additional spring suspension or damping effect. In the exemplary embodiment in FIG. 3, in the case of each deflection of the working piston 18, either the rebound stage suspension arrangement 40 or the compression stage suspension arrangement 52 is active, so that a force is applied to the working piston 18 in the direction of the centre position in the case of each deflection.

### LIST OF REFERENCE SIGNS

10 Vibration damper
12 Outer tube
14 Damper tube/inner tube
16 Compensation chamber
18 Working piston
20 Piston rod
22 First working chamber
24 Second working chamber
26 Valve device of the working piston
28 Seal
30 Sealing ring
32 Rebound stage piston
34 Closure package
36 Bottom piece
38 Bottom valve
40 Rebound stage suspension arrangement
42 Rebound stage spring
42a First rebound stage spring
42b Second rebound stage spring
44 Rebound stage spring seat
46 Groove in rebound stage piston
48 Check valve
50 Gas chamber
52 Compression stage suspension arrangement
54 Compression stage piston
56 Compression stage spring
56a First compression stage spring
56b Second compression stage spring
58 Compression stage spring seat
60 Groove in compression stage piston
62 Flow passage
64 Separating piston
66 Hydraulic chamber
68 Gas chamber
70 Sealing ring

1. A vibration damper for a vehicle, comprising:
a damper tube filled with hydraulic fluid;
a working piston, which is connected to a piston rod and is arranged movably back and forth inside the damper tube, the interior of the damper tube being divided by the working piston into a first working chamber on the piston rod side and a second working chamber away from the piston rod;
a rebound stage suspension arrangement for applying a spring force to the working piston during a piston rod movement in the rebound direction, including a rebound stage piston, which is mounted on the piston rod, and a rebound stage spring, and a compression stage suspension arrangement for applying a spring force to the working piston during a piston rod movement in the compression direction, including a compression stage piston and a compression stage spring.

2. The vibration damper according to claim 1, wherein the rebound stage suspension arrangement and the compression stage suspension arrangement are mechanically separate from one another inside the vibration damper.

3. The vibration damper according to claim 1, wherein the rebound stage suspension arrangement and the compression stage suspension arrangement are designed and arranged such that they apply a force to the working piston in the direction of the centre position of the working piston, in which the working piston is located in the axial centre of the damper tube.

4. The vibration damper according to claim 1, wherein the piston rod is movable within a movement range in which both the rebound stage suspension arrangement and the compression stage suspension arrangement are inactive, in particular do not produce any additional spring suspension effect.

5. The vibration damper according to claim 4, wherein the movement range includes the centre position of the piston rod, in which the working piston is located in the axial centre of the damper tube.

6. The vibration damper according to claim 1, wherein one end of the rebound stage spring and one end of the compression stage spring are fastened inside the damper tube.

7. The vibration damper according to claim 1, wherein the rebound stage spring is fastened to the rebound stage piston and/or to a rebound stage spring seat located inside the damper tube.

8. The vibration damper according to claim 1, wherein the compression stage spring is fastened to the compression stage piston and/or to a compression stage spring seat located inside the damper tube.

9. The vibration damper according to claim 1, wherein the rebound stage spring and/or the compression stage spring are mounted with the ability to move axially inside the damper tube.

10. The vibration damper according to claim 1, wherein the rebound stage spring and/or the compression stage spring has a length which is less than half the length of the damper tube.

11. The vibration damper according to claim 1, wherein the rebound stage spring and the compression stage spring have the same spring rates.

12. The vibration damper according to claim 1, wherein the rebound stage suspension arrangement and/or the compression stage suspension arrangement each have at least two mutually mechanically parallel springs.

13. The vibration damper according to claim 1, wherein the vibration damper has an outer tube arranged coaxially around the damper tube and wherein a compensation chamber at least partially filled with hydraulic fluid is located between the damper tube and the outer tube.

14. A vehicle, comprising:
a vehicle body;
a steering rod;
a steering axle; and
a vibration damper according to claim 1;
wherein the vibration damper is fastened to the steering rod and/or to the steering axle and/or to the vehicle body.
